(19) United States
(12) Patent Application Publication
(10) Pub. No.: US 2006/0259928 A1
(43) Pub. Date: Nov. 16, 2006

(54) Method and arrangement for monitoring telecommunication activities

(76) Inventors: Luca Di Serio, Nocera Inferiore (IT); Roberto Cicco, Cava de Tirreni (SA) (IT); Enrico De Luca, Caserta (IT); Maurizio Iovieno, Mercato San Severino (SA) (IT)

Correspondence Address: ERICSSON INC., 6300 LEGACY DRIVE, M/S EVR C11, PLANO, TX, 75024, US

(21) Appl. No.: 11/276,907

(22) Filed: Mar. 17, 2006

(30) Foreign Application Priority Data
Mar. 18, 2005 (WO) PCT/SE05/00406

(51) Int. Cl. H04N 7/16; H04M 1/00

(52) U.S. Cl. 725/62; 455/550.1

(57) ABSTRACT

The present invention relates to methods and arrangements in a telecommunication system to monitor telecommunication activities within a specified area, which system comprises an access Point ICE associated with a Configuration Unit ICU, which method comprises the following steps: Receiving to the Access Point ICE from the Configuration Unit ICU, a request 11 to monitor telecommunication activities related to all non-excluded telecommunication members MS within a defined area LA1. register in the Access Point ICE, a telecommunication activity related to a member MSB within the defined area LA1. establish, in the Access Point ICE, that the member MSB is a non-excluded member. delivering information IRI, CC related to the non-excluded member MSB, from the Access point ICE to the Configuration Unit ICU.

### TECHNICAL FIELD OF THE INVENTION

The present invention relates to methods and arrangements in a telecommunication system to generate information related to telecommunication activities in a defined area.

### DESCRIPTION OF RELATED ART

Increasing amount of data traffic as well as real-time communication has lead to a demand for monitoring. One kind of monitoring is lawful interception, i.e. the act of intercepting a communication on behalf of a Law Enforcement Agency. Interception of Content of Communication CC i.e. speech and data is known. Interception of intercept Related information IRI is also known. Intercept Related Information is defined as signaling information related to target subscribers, for example call establishment. In Circuit Switching domain, the sending of IRI to a monitoring function is triggered by different call related and non-call related events. Appropriate session related and session unrelated events trigger the sending of IRI to a monitoring function in case of Packet Switching communication.

The ETSI standard defines the possibility to have location dependant interception. This dependency allows a Law Enforcement Agency to define a boundary area in which a mobile subscriber can be intercepted. In this way it can be avoided to intercept a subscriber beyond the area under LEA jurisdiction. Problems with existing solutions is that according to the current LI standards, lawful interception is activated on a per target identity basis and the location dependent interception only allows to define the boundary of the interception for the given target identity (see 3GPP TS 33.107 “Lawful interception and functions” (release 6) and 3GPP TS 33.108 “Handover interface for Lawful Interception” (release 6). It is not possible to intercept all the incoming and outgoing calls/sessions and telecommunication activities in a predefined area (e.g. a particular cell) for all the subscribers who are currently in that area. This limitation is relevant in case e.g., under a specific legal authorization, there is a need to protect a very sensitive area and intercept all communications in that area.

### SUMMARY OF THE INVENTION

The present invention relates to a problem how to legally intercept telecommunication activities for all members in a specified area in a telecommunication system.

The problem is solved by the invent-on by introducing a new target identity related to a defined area. The new target identity allows monitoring of outgoing and incoming calls/sessions and other telecommunication activities from/to the defined area for all members within the area.

More in detail, the problem is solved by a method and arrangement in a telecommunication system to monitor, under specific legal authorization, telecommunication activities for all members within a specified area. The system comprises an Access Point associated with a Configuration Unit. The method comprises the following steps:
Receiving to the Access Point from the Configuration Unit, a request to monitor telecommunication activities for all telecommunication members within a defined area.
Registration in the Access Point, of a telecommunication activity related to a member within the defined area.
Delivering information related to the member, from the Access point to the Configuration unit.

An object of the invention is to facilitate interception of telecommunication activities related to all members in a defined area.

The present invention also relates to a further problem how to monitor all non-excluded members in a specified area in a telecommunication system.

The problem is solved by the invention by introducing a new target identity related to a defined area. The new target identity allows monitoring of outgoing and incoming calls/sessions and other telecommunication activities from/to the defined area for all non-excluded members.

More in detail, the further problem is solved by a method and arrangement in a telecommunication system to monitor telecommunication activities for all members within a specified area. The system comprises an Access Point associated with a Configuration Unit. The method comprises the following steps:
Receiving to the Access Point from the Configuration Unit, a request to monitor telecommunication activities for all non-excluded telecommunication members within a defined area.
Register in the Access Point, a telecommunication activity related to a member within the defined area.
Establish in the Access Point (IAP, ICE), that the member is a non-excluded member.
Deliver information related to the member, from the Access Point to the Configuration Unit.

A further object of the invention is to facilitate interception of telecommunication activities related to all non-excluded members in a defined area.

Advantages of the invention are that interception based on the cell identity gives Law Enforcement Agencies the possibility to intercept all calls/sessions in a specific sensitive geographical area without the need to know any specific target subscription identity in advance. This is relevant in case e.g. there is a need to protect very sensitive areas.

The invention will now be described more in detail with the aid of preferred embodiments in connection with the enclosed drawings.

### BRIEF DESCRIPTION OF THE DRAWINGS

FIG. 1 discloses in a three-dimensional view a block schematic illustration of a prior art communication system that communicates in packet and circuit domains.

FIG. 2 discloses a block schematic illustration of the invention when used to monitor all members within a cell in a circuit domain based system.

FIG. 3 discloses a black schematic illustration of the invention when used to monitor all members except members with special privileges within a location area in a circuit domain based system.

FIG. 4 discloses a flow chart illustrating some essential method steps of the invention.

FIG. 5 discloses a block schematic illustration of the invention when used to monitor members within a defined area in a packet domain based system.

### DETAILED DESCRIPTION OF EMBODIMENTS

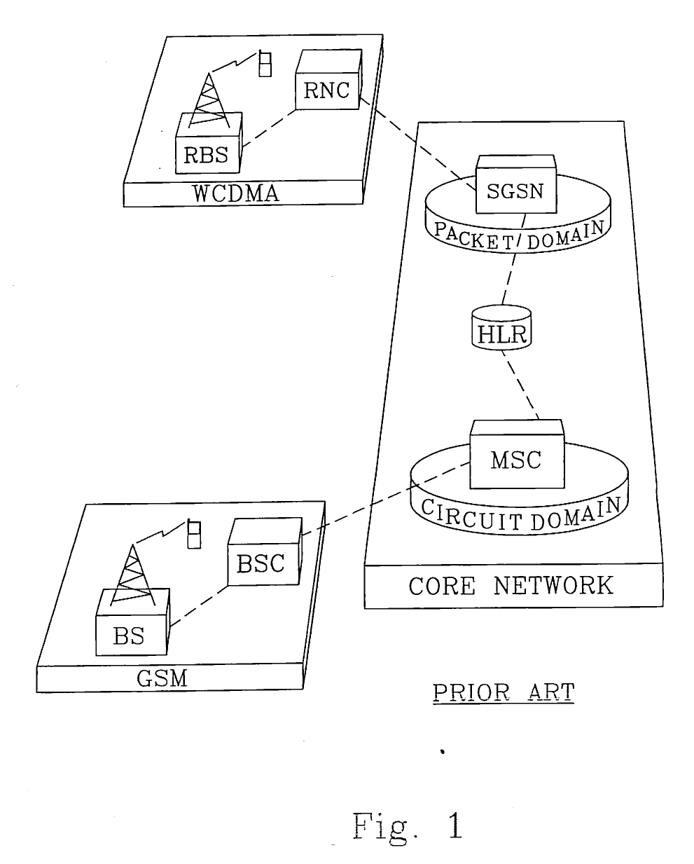

FIG. 1 discloses a block diagram of a prior art wireless communication system. The system comprises radio network subsystems such as a Radio Network Controller RNC in a WCDMA system and a Base Station Controller BSC in a GSM system. The radio network subsystems are in communication with a CORE NETWORK. The WCDMA system is connected to a Serving GPRS Support Node SGSN in PACKET DOMAIN in the core network. The GSM system is connected to a Mobile Services Switching Center MSC in CIRCUIT DOMAIN in the core network. A Home Location Register HLR in the core network is connected to the SGSN and to the MSC.

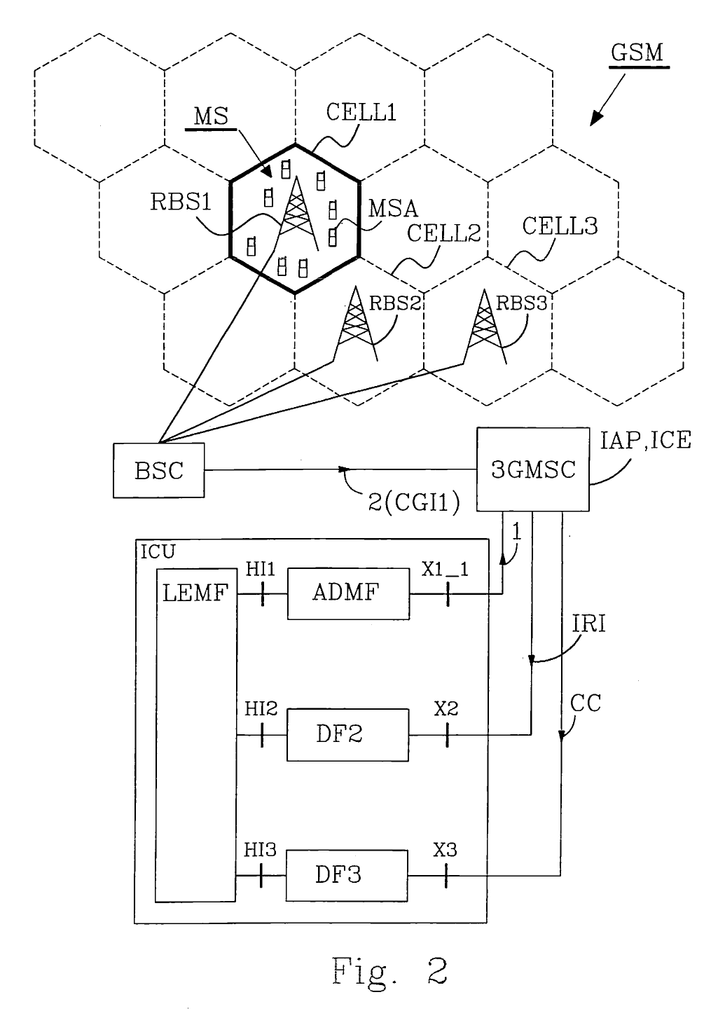

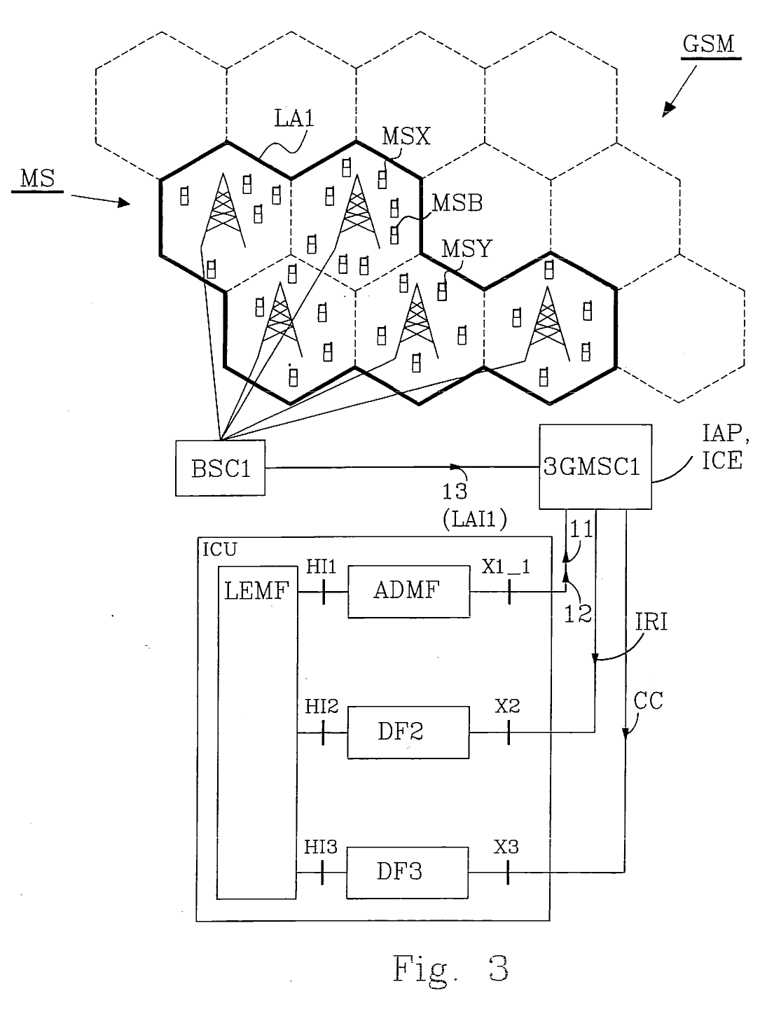

Two embodiments of the invention will now be explained more in detail together with FIG. 2 and 3. The two figures are parts of the FIG. 1 discussed above, and relates to monitoring of telecommunication system members (i.e. subscribers and equipments) within defined areas in a circuit domain based system of GSM type. FIG. 2 relates to monitoring of all members within a defined cell area and FIG. 3 relates to monitoring of all non-excluded members within a defined location area. To be noted is that both embodiments are applicable in both circuit and packet domain based systems.

FIG. 2 discloses a first embodiment of the invention. An Intercept Configuration Unit ICU is disclosed in FIG. 2. The different parts of the ICU belong to prior art and are disclosed in current Lawful Interception standards (see 3GPP TS 33.108 and 3GPP TS 33.107—Release 6). The ICU comprises a Law Enforcement Monitoring Function LEMF. The LEMF is connected to three Mediation Functions respectively for ADMF, DF2, DF3 i.e. an Administration Function ADMF and two Delivery Functions DF2 and DF3. The Administration Function and the Delivery Functions are each one connected to the LEMF via standardized interfaces H1-H3, and connected to the telecommunication network via the interfaces X1-X3. The ADMF is connected via the interfaces HI1/X1_1 while DF2 is connected via HI2/X2 and DF3 is connected via HI3/X3. The messages sent from LEMF to ADMF via HI1 and from the ADMF to the network via the X1_1 interface comprise identities of a target that is to be monitored. The Delivery Function DF2 receives Intercept Related Information IRI from the network via the X2 interface, and DF2 is used to distribute the IRI to relevant Law Enforcement Agencies via the HI2 interface. The Delivery Function DF3 receives Content of Communication CC, i.e. speech and data. In Circuit Switching, DF3 is responsible for call control signaling and bearer transport for an intercepted product. Intercept Related Information IRI, received by DF2 is triggered by Events that in Circuit Switching domain are either call related or non-call related. In Packet Switching domain the events are session related or session unrelated.

In this first embodiment related to a GSM network the Administration Function ADMF is connected via the X1_1 interface to a Mobile Services Switching Center 3GMSC, i.e. to the so-called Intercept Access point IAP (or Intercepting Control Element ICE when 3GPP terminology is used). The Delivery Function DF2 is connected to the 3GMSC via the X2 interface and “he DF3 is connected to the 3GMSC via the X3 interface. The 3GMSC is also connected to a Base Station Controller BSC. A cell cluster (dashed lines) can be seen in FIG. 2. Each CELL in the cluster is an area of radio coverage and comprises a Radio Base Station RBS operating on a set of radio channels. The Base Station Controller BSC controls a group of RBSs. The BSC in the example in FIG. 2 is connected to, and controls RBS1, RBS2 and RBS3. The different RBSs composes each one, one cell area, in this example CELL1, CELL2 and CELL3. The telecommunication network identifies each cell, by a Cell Global Identity CGI. The Cell Global Identity is a concatenation of Location Area Identity and Cell Identity and uniquely identifies a given cell. A Cell Global Identity CGI1 identifies CELL1. CELL1 is shown in the figure with thick lines. Different members MS of the telecommunication system such as mobile subscribers/equipments are in this example located within CELL1. A mobile subscriber MSA constitutes one of the members MS within CELL1.

A method according to the first embodiment of the invention will now be explained more in detail. The explanation is to be read together with FIG. 2. The method comprises the following steps:
The Law Enforcement Monitoring Function LEMF sends via the HI1 interface, a request 1 to the Administration Function ADMF to activate interception of telecommunication activities for all members within CELL1. The Global Cell Identity CGI1 is sent in the request 1 and defines CELL1.
The ADMF forwards the requests 1 via the interface X1_1 to the Mobile Services Switching Center 3GMSC. The received Global Cell Identity CGI1 is stored in the 3GMSC.
A call set-up request message 2 is sent from the mobile subscriber MSA to the 3GMSC. The call set-up message comprises an identification CGI1 of the cell from which the request arrives, i.e. From CELL1. This telecommunication activity is received to the 3GMSC.
The Global Cell Identity CGI1, which identifies CELL1 as the cell from which the request arrives is received in the 3GMSC. The International Mobile Equipment Identity IMEI, the International Mobile Subscriber Identity IMSI or the Mobile Station International ISDN Number identifies the member MSA. The received information is stored in the 3GMSC.
The 3GMSC verifies that the received Global Cell Identity CGI1 is an intercepted target.
The 3GMSC forwards Intercept Related Information IRI related to the member MSA via the X2 interface to the delivery function DF2 and from DF2 to the Law Enforcement Monitoring Function LEMF via the HI2 interface.
The 3GMSC for-wards Content of Communication CC related to the member MSA via the X3 interface to the delivery function DF3 and from DF3 to the LEMF via the HI3 interface.

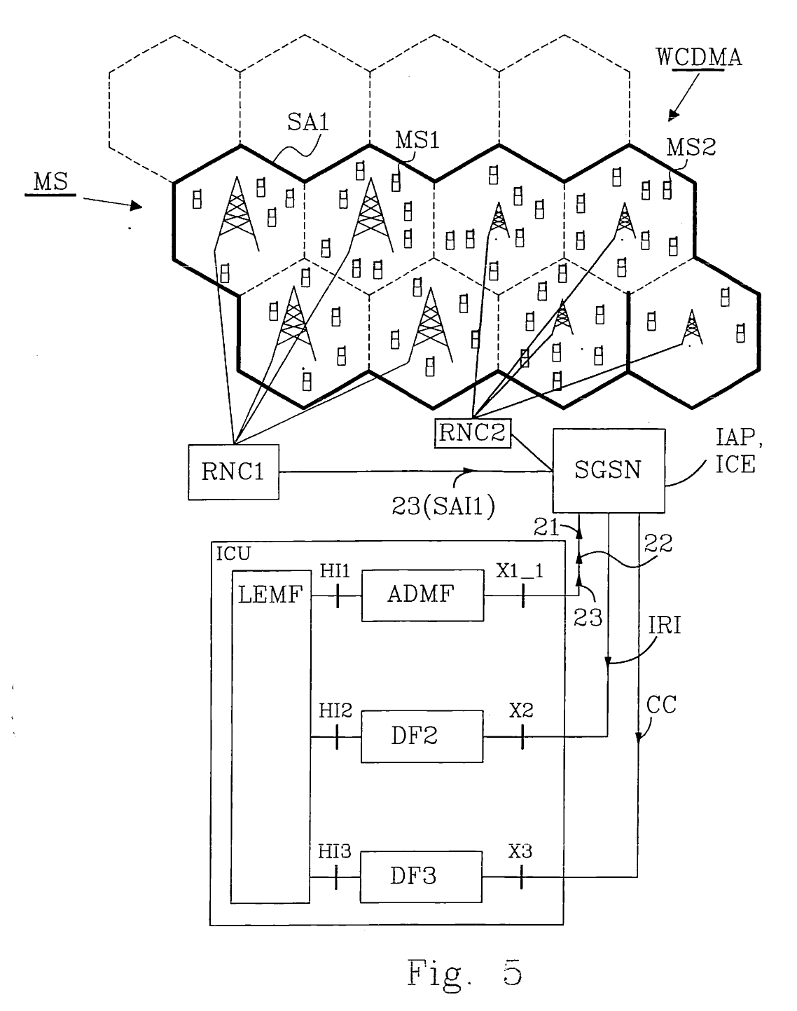

To summarize: When LEMF orders an interception of telecommunication activities for all members within a certain target area to ADMF, the area identity is included in the X1 interface towards the 3GMSC or the SGSN (see FIG. 5) when activating the interception. When an outgoing or incoming call/session or telecommunication activities from/to a member within the defined area, the 3GMSC (or the SGSN) sends Intercept Related Information IRI and possibly (depending on the authorization, Content of Communication CC to the DF2 and DF3 respectively according to existing mechanism in the standards. Correlation between IRIs related to the same member and between IRIs and CC related to the same member will be achieved by using the mechanisms defined in the standards, which depend on the technology. Important to note is that both incoming and outgoing activities to the defined area will be handled in the above described way. For an incoming activity to the area, CGI will be identified in the 3GMSC e.g. during the internal paging procedure;

FIG. 3 discloses a second embodiment of the invention. .An identical Intercept Configuration Unit ICU as disclosed in FIG. 2 is now disclosed in FIG. 3.

In this second embodiment the Administration Function ADMF is connected via the X1_1 interface to a Mobile Services Switching Center 3GMSC1, i.e. to the IAP (or ICE). The Delivery Function DF2 is connected to the 3GMSC1 via the X2 interface and the DF3 is connected to the 3GMSC1 via the X3 interface. The 3GMSC1 is connected to a Base Station Controller BSC1. A cell cluster (dashed lines) is disclosed in FIG. 3. Each mobile services switching center in the system is divided into several location areas. A Location Area LA1 that comprises different cells is handled by 3GMSC1 and can be seen in FIG. 3 (LA1 is shown in the figure with thick lines). A Base Station Controller BSC1 controls in this example a group of Radio Base Stations within the Location Area LA1. The telecommunication network identifies different location areas by a Location Area Identity LAI. Different members MS of the telecommunication system i.e. mobile subscribers/equipments are in this example located within LA1. Included among the different members are two mobile subscribers MSX and MSY which have been defined by a Law Enforcement Agency as members with special privileges for which interception not is to take place in the given area. This “exception list” is communicated by the Lawful Enforcement Agency and stored in the Lawful Interception network that is handled by the operator. Examples of members with special privileges could be governors, ministers, or people whose privacy needs to be protected and are not considered possible targets for interception. More in general, this “exception list” could contain the list of members who are authorized to have not-intercepted communication inside the sensitive area prom which all other communications will need to be intercepted.

A method according to the second embodiment of the invention will now be explained more in detail. The explanation is to be read together with FIG. 3. The method comprises the following steps:
The Law Enforcement Monitoring Function LEMF sends via the HI1 interface, a request 11 to the Administration Function ADMF to activate interception of all members within the Location Area LA1. LA1 is defined by the Location Area Identity LAI1, which is sent in the request 11.
The Law Enforcement Monitoring Function LEMF sends via the HI1 interface, a further request 12 to the Administration Function ADMF to exclude certain, in the request 12 defined, members MSX and MSY from monitoring in that area. The requests 11 and 12 may be sent separately or together as parameters in the same message.
The ADMF forwards the requests 11 and 12 via the interface X1_1 to the Mobile Services Switching Center 3GMSC1. The received Location Area Identity LAI1 and the identity of the excluded members are stored in the 3GMSC1.
A call set-up request message 13 is sent from a member MSB within the Location Area LA1 to the 3GMSC1. The call set-up message comprises a location area identity LAI1 of the Location Area LA1 from which the request arrives. This telecommunication activity is received to the 3GMSC1.
The Location Area Identity LAI1, which identifies LA1 as the Location Area from which the request arrives is received in the 3GMSC1. The International Mobile Equipment Identity IMEI, the International Mobile Subscriber Identity IMSI or the Mobile Station International ISDN Number identifies MSB. The received information is stored in the 3GMSC1.
The 3GMSC1 verifies that the received Location Area Identity LAI1 is identical to the received target identity from ADMF identified as target under interception.
The 3GMSC1 compares MSB with stored information of excluded members MSX and MSB and verifies that the member MSB is a non-excluded member.
The 3GMSC1 forwards Intercept Related Information IRI and Content of Communication CC to the Law Enforcement Monitoring Function LEMF via the delivery function DF2 and DF3 respectively. To be noted is that if the telecommunication activity instead was initiated from one of the excluded members MSX or MSY, this last method step would have not existed.

As a variation to the above embodiment, all members within the location area LA1 can be defined as non-excluded members in the further request 12. As yet another alternative, all members within the location area LA1 can be pre-defined in the system as non-excluded members.

In the two embodiments just described instead of forwarding Cell Global Identity and Location Area Identity from the Law Enforcement Monitoring Function to the Intercept Access Point, a geographical area can be defined. The geographical area is then coded according to 3GPP TS 23.032 “Universal Geographical Area description (GAD)”—release 6.

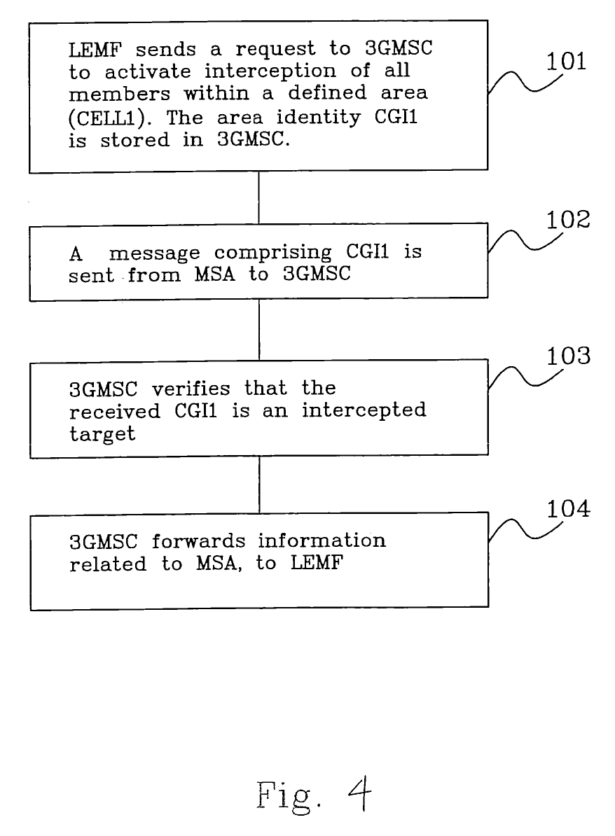

FIG. 4 discloses a flowchart in which some of the more important steps are shown. The flowchart is to be read together with the earlier shown figures. The flowchart comprises the following steps:
The Law Enforcement Monitoring Function LEMF sends a request to the Mobile Services Switching Center 3GMSC to activate interception of telecommunication activities for all members within the defined area CELL1. The Global Cell Identity CGI1 defines CELL1 in the request. The received Global Cell Identity CGI1 is stored in the 3GMSC. This step is disclosed in FIG. 4 by a block 101.
A call set-up request message is sent from the mobile subscriber MSA to the 3GMSC. The call set-up message comprises the identification CGI1 of the cell from which the request arrives, i.e. from CELL1. This telecommunication activity is received to the 3GMSC. This step is disclosed in FIG. 4 by a block 102.
The 3GMSC verifies that the received Global Cell Identity CGI1 is an intercepted target. This step is disclosed in FIG. 4 by a block 103.
The 3GMSC forwards Intercept Related Information IRI related to the member MSA to the Law Enforcement Monitoring Function This step is disclosed in FIG. 4 by a block 104.

FIG. 5 discloses a third embodiment of the invention now relating to a WCDMA network. An identical ICU already disclosed in FIG. 2 and 3 is disclosed in FIG. 5. The system in the third embodiment is of type Packet Switching Communication and appropriate session related and session unrelated events trigger the sending of IRI and/or CC to the LEMF.

In this third embodiment the Administration Function ADMF is connected to a Serving GPRS Support Node SGSN via the X1_1 interface. The Delivery Function DF2 is connected to the SGSN via the X2 interface and the DF3 is connected to the SGSN via the X3 interface. A cell cluster (dashed lines) is disclosed in FIG. 5. Two Radio Network Controllers RNC1 and RNC2 handle in this example a Service Area SA1 (SA1 is shown in the figure with thick lines). The RNCs control a group of Radio Base Stations within the Service Area SA1. The telecommunication network identifies different service areas by a Service Area Identity SAI. The SAI is used in WCDMA networks to determine physical location of a user. A Service Area Identity SAI1 identifies SA1. Different members MS, MS1, MS2 of the telecommunication system are in this example located within SA1.

This third embodiment relates to avoid exceeding interception resources in the system. When activating a service identity, i.e. SA1 in this embodiment, it is possible to define, as option, a threshold value. If the sum of outgoing and incoming calls from/to the area exceeds the threshold value, any further call from/to that cell will not be intercepted. This is needed to avoid that all the calls pertaining to a specific area consume all the interception resources of the network.

A method according to the third embodiment of the invention will now be explained more in detail. The explanation is to be read together with FIG. 5. The method comprises the following steps:
The Law Enforcement Monitoring Function LEMF sends a request 21 to the Administration Function ADMF to activate interception of telecommunication activities related to all (non-excluded) members within the Service Area SA1. SA1 is defined by the Service Area Identity SAI1, which is sent in the request 21.
The Law Enforcement Monitoring Function LEMF sends via the HI1 interface, a further request comprising a threshold value 22 that defines the maximum number of allowed simultaneous intercepted targets.
The ADMF forwards 21 and 22 via the interface X1_1 to the Serving GPRS Support Node SGSN. The received Service Area Identity SAI1 and the threshold value are stored in the SGSN.
In this method step, various session related and session unrelated telecommunication activities are sent from members MS within the Service Area SA1 to the SGSN. The messages all comprise a Service Area Identity SAI1 of the Service area SA1 from which they arrive or are destined.
For each received activity to the SGSN, the SGSN verifies that the received Service Area Identity SAI1 is identical to the received target identity from ADMF and forwards after positive confirmation relevant IRI and CC to the Law Enforcement Monitoring Function LEMF.
The total number or simultaneous intercepted targets reaches the threshold value.
When the number of simultaneous intercepted members in the given area reaches the threshold value, the network will not intercept further members from that area, i.e. will not send IRI and/or CC for further members until the number of members simultaneously under interception again is less than the threshold value.

In addition, the network may send information, such as an alarm, to the LEMF via HI2 or HI2 interface. As further options, mechanisms could be foreseen so that, even in case the number of members under interception is greater than the threshold value, interception will be still provided for IRI only or for both IRI/CC in case a member whose identity(ies) is (are) targeted for lawful interception according to the already existing mechanisms enters the given area.

As a variation valid for all above described embodiments, a further request (24) comprising a definition of telecommunication activities for which for which monitoring shall take place can be received to the Access Point IAP, ICE from the Configuration Unit ICU. The invention is in other words not limited to the above described and in the drawings shown embodiments but can be modified within the scope of the enclosed claims. As already mentioned, embodiments are applicable in both circuit and packet domain based systems. Different internal order between different method steps can vary. Any of for example 3GMSC, 3GGMSC, SGSN or GGSN can be used as Intercept Access Point.

1. A method in a telecommunication system to monitor telecommunication activities within a specified area, which system comprises an access Point associated with a Configuration Unit, comprising the following steps:
receiving to the Access Point from the Configuration Unit, a request to monitor telecommunication activities related to all non-excluded telecommunication members within a defined area;
register in the Access Point, a telecommunication activity related to a member within the defined area;
establish, in the Access Point, that the member is a non-excluded member;
delivering information related to the non-excluded member, from the Access point to the Configuration Unit.

2. The method of claim 1, further comprising: receiving to the Access Point from the configuration Unit, a further request to exclude members from monitoring, which excluded members are defined in the further request.

3. The method of claim 1, further comprising:
receiving to the Access Point from the configuration Unit, a further request defining all members within the defined area as non-excluded members.

4. The method of claim 1, further comprising:
all members within the defined area are pre-defined in the Access Point as non-excluded members.

5. The method of claim 1, further comprising:
receiving to the Access Point from the Configuration Unit, a further request comprising a threshold value;
receiving to the Access Point, telecommunication activities from various members within the defined area;
delivering information related to the various members, from the Access Point to the configuration unit;
total number of simultaneous intercepted members reaches the threshold value.

6. The method of claim 5, further comprising:
prevent delivering information to further members in excess of the threshold value, from the Access Point to the configuration unit, until the number of members simultaneously under interception again is less than the threshold value.

7. The method of claim 5, further comprising the step of:
prevent delivering information beyond Intercept Related Information, to further members in excess of the threshold value, from the Access Point to the configuration unit, until the number of members simultaneously under interception again is less than the threshold value.

8. The method of claim 5, further comprising the step of Method in a telecommunication system to monitor telecommunication activities within a specified area according to claim 5, comprising the following further step: preventing information delivery to further members in excess of the threshold value, beyond members already targeted for Lawful Interception, from the Access Point to the configuration unit, until the number of members simultaneously under interception again is less than the threshold value.

9. The method of claim 1, further comprising the step of:
receiving to the Access Point from the Configuration Unit (ICU) a further request comprising a definition of telecommunication activities for which for which monitoring shall take place.

10. A method in a telecommunication system to monitor telecommunication activities within a specified area, which system comprises an access Point associated with a Configuration Unit (ICU), the method comprising the following steps:
receiving to the Access Point from the Configuration Unit, a request to monitor telecommunication activities related to all telecommunication members (MS) within a defined area;
register in the Access Point, a telecommunication activity related to a member within the defined area;
delivering information related to the member, from the Access point to the Configuration Unit.

11. An arrangement in a telecommunication system to monitor telecommunication activities within a specified area, which system comprises an access Point associated with a Configuration Unit, comprising:
means for receiving to the Access Point from the Configuration Unit, a request to monitor telecommunication activities related to all non-excluded telecommunication members within a defined area;
means for register in the Access Point, a telecommunication activity related to a member within the defined area;
means for establish, in the Access Point, that the member is a non-excluded member;
means for delivering information related to the non-excluded member, from the Access point to the Configuration Unit.

12. The arrangement of claim 11, further comprising:
means for receiving to the Access Point from the configuration Unit, a further request to exclude members from monitoring, which excluded members are defined in the further request.

13. The arrangement of claim 11, further comprising:
means for receiving to the Access Point from the configuration Unit, a further request defining all members within the defined area as non-excluded members.

14. The arrangement of claim 11, further comprising:
means in the Access point to pre-define all members within the defined area as non-excluded members.

15. The arrangement of claim 11, further comprising:
means for receiving to the Access Point from the Configuration Unit, a further request comprising a threshold value;
means for receiving to the Access Point, telecommunication activities from various members within the defined area;
means for delivering information related to the various members, from the Access Point to the configuration unit;
means to register that total number of simultaneous intercepted members reaches the threshold value.

16. The arrangement of claim 15, further comprising:
means to prevent delivering information to further members in excess of the threshold value, from the Access Point to the configuration unit, until the number of members simultaneously under interception again is less than the threshold value.

17. The arrangement of claim 15, further comprising:
means to prevent delivering information beyond Intercept Related Information, to further members in excess of the threshold value, from the Access Point to the configuration unit, until the number of members simultaneously under interception again is less than the threshold value.

18. The arrangement of claim 15, further comprising:
means to prevent delivering information to further members in excess of the threshold value, beyond members already targeted for Lawful Interception, from the Access Point to the configuration unit, until the number of members simultaneously under interception again is less than the threshold value.

19. The arrangement of claim 11, further comprising:
means for receiving to the Access Point from the Configuration Unit a further request comprising a definition of telecommunication activities for which for which monitoring shall take place.
